(19) United States
(12) Patent Application Publication
(10) Pub. No.: US 2012/0166253 A1
(43) Pub. Date: Jun. 28, 2012

(54) NO-DIAL CELL PHONE INTERVIEWING SYSTEM AND METHOD

(75) Inventors: Michael Yerkovich, Seattle, WA (US); William Marshall Leath, III, Seattle, WA (US)

(73) Assignee: PINNION, INC., Kirkland, WA (US)

(21) Appl. No.: 13/339,306

(22) Filed: Dec. 28, 2011

Related U.S. Application Data
(60) Provisional application No. 61/427,727, filed on Dec. 28, 2010.

(51) Int. Cl. G06Q 30/02

(52) U.S. Cl. 705/7.32

(57) ABSTRACT

A no-dial cell phone interviewing system and method have a server, a user interface module, a campaign design and creation module configured to select a plurality of survey questions, an incentive module configured to select and communicate an object of value, a first round distribution module, a second round distribution module, a distribution adjustment module configured to adjust the communication of at least one survey question of the plurality of survey questions, a data collection and presentation module configured to receive answers to the at least one survey question, and a privacy protection module configured to protect the privacy of a user that answered the at least one survey question.

### CROSS-REFERENCE(S) TO RELATED APPLICATION(S)

This application claims the benefit under 35 U.S.C. §119(e) of U.S. Provisional Patent Application No. 61/427,727, filed Dec. 28, 2010, which is incorporated herein by reference in its entirety.

### BACKGROUND

1. Technical Field

This disclosure generally relates to the field of user surveys and more particularly related to a no-dial cell phone interviewing system and method.

2. Description of the Related Art

In market research, public opinion, and other research fields it is desirable to obtain input from individuals who fall into a specific category, demographic, grouping, or other “frame.” There are many modes by which this input can be collected. Certain modes of interfacing with the individuals within the frame are more desirable than others depending on the nature of the information to be gathered.

For example, certain types of questions that might be termed as “open ended” by researchers within these industries, are more accurately collected by way of a real-time, full duplex, oral discussion between a trained interviewer and the individual from whom the data is collected, the interviewee. Methods currently used to perform open-ended data collection include “field interviews,” which are conducted in person, and telephone interviews, which involve operator administered interviewing using an electronic device such as a telephone. For example, in such conventional survey systems, an operator will dial a phone number in an attempt to contact a live person, qualify the person for the survey, and conduct the survey.

Field interview data collection involves significantly increased costs by comparison to other methods of data collection commonly in use. Further, the use of field interviews is generally reserved for cases where other options yield unacceptable results because the costs associated with field interviews are typically greater than those associated with similar interviews such as interviews conducted over the telephone.

Outside of additional factors that lead to in-person contact, field interviews are generally used as a last resort, e.g., when there is no other more reasonable means of contacting some or all of the individuals within the frame. Failure to collect the data from some of the individuals within a frame may be unavoidable. Further, efforts to contact the individuals to be interviewed can be protracted and do not necessarily result in successful data collection.

Nevertheless, the failure rate or degree to which the interviewers are unsuccessful in completing these interviews can have a significant impact on the quality and credibility of the results for the entire project. This failure rate can be a key factor in determining the overall Response Rate.

The Response Rate is the percentage of all individuals selected for interviewing who are successfully interviewed via any method. Often, when response rates are unacceptably low, additional efforts are made to increase the response rate.

Efforts to increase a response rate can include escalation from a less expensive form of data collection to the costly interviews described above. In data collection projects where certain efforts have already been made, additional attempts can be undertaken to contact more of the individuals within the identified frame. Ultimately, the possibility exists that the entire data collection project may need to be redone as a result of poor data quality stemming from inadequate response rates or other factors. In fact, several factors can combine to increase the costs of data collection efforts in order to improve response rates.

Currently, there is a growth in both Cell Phone Only (CPO) and Cell Phone Mostly (CPM) households. CPO households are those that have cancelled or opted not to establish conventional, “land-line” home telephone service. CPO households can be telephoned solely through their cell phone.

Similar to CPO households are CPM households. CPM households currently maintain land line telephone service to their residence. Nevertheless, CPM household occupants have indicated that they are more likely to answer a telephone call on their cell phone at home than on their land line. Within the CPM group many do not answer any inbound calls over their landline. CPO households have grown from less than 4% of US households in 2003, to over 25% of US Households in 2010.

Currently, for data collection studies that include geographic bounds in their frame, potential respondents are selected based on the residential address associated with a telephone number. Cell phone numbers are typically not searchable by address, however, nor are the area codes or exchange prefixes indicative of geographic location due to cell phone number mobility.

### BRIEF SUMMARY

In one embodiment, a no-dial cell phone interviewing system and method have a server, a user interface module, a campaign design and creation module configured to select a plurality of survey questions, an incentive module configured to select and communicate an object of value, a first round distribution module, a second round distribution module, a distribution adjustment module configured to adjust the communication of at least one survey question of the plurality of survey questions, a data collection and presentation module configured to receive answers to the at least one survey question, and a privacy protection module configured to protect the privacy of a user that answered the at least one survey question.

In an embodiment, mobile device interviewing system includes a computing server having a database, an electronic user interface module directed by the server, and a campaign design and creation module configured to select a plurality of survey questions. A first round distribution module is configured to automatically distribute, via the electronic user interface, a first phase survey created by the campaign design and creation module to a plurality of mobile devices, and each mobile device is respectively controllable by a prospective survey taker. A second round distribution module is configured to automatically distribute a second phase survey to a subset of the plurality of mobile devices, the subset includes the mobile devices respectively controllable by prospective survey takers that have qualified and accepted participation in the second phase survey. A distribution adjustment module is configured to monitor delivery and completion of the first phase survey in preparation for distribution of the second phase survey.

The mobile device interviewing system also includes a data collection and presentation module configured to receive answers to the first phase survey and the second phase survey, and the data collection and presentation module is further configured to store the received answers in the database. A privacy protection module is configured to protect privacy data communicated by respective ones of the plurality of mobile devices.

In another embodiment, a no-dial cell phone server includes a database, a client/user interface circuit configured to wirelessly communicate with a plurality of mobile devices, the client/user interface configured to accept input data from a survey commissioning client device and further used to pass output data to the survey commissioning client device, and a survey campaign design and creation module configured to direct creation of a user survey based on the input data. An incentive module is configured to manage a plurality of user survey incentives, the user survey incentives associated with the user survey, a respective one of the user survey incentives automatically delivered in real-time to the mobile device upon completion of the user survey.

In still one more embodiment, a non-transitory computer-readable storage medium has stored contents to configure a computing system to perform a method. The method includes the acts of directing a campaign design and creation module to select a plurality of survey questions, a first subset of the plurality of survey questions form a first phase survey and a second subset of the plurality of survey questions form a second phase survey. The method also includes the acts of automatically distributing the first phase survey to a plurality of mobile devices, each mobile device respectively controllable by a prospective survey taker, and automatically distributing the second phase survey to a subset of the plurality of mobile devices, the subset including the mobile devices respectively controllable by prospective survey takers that have accepted participation in the second phase survey. The method includes the acts of monitoring delivery and completion of the first phase survey in preparation for distribution of the second phase survey, receiving answers to the first phase survey and the second phase survey, and delivering a user survey incentive to the subset of the plurality of mobile devices based on receiving the answers to the second phase survey.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements and angles are not drawn to scale, and some of these elements are enlarged and positioned to improve drawing legibility.

Further, the particular shapes of the elements as drawn are not intended to convey any information regarding the actual shape of the particular elements and have been solely selected for ease of recognition in the drawings. One or more embodiments are described hereinafter with reference to the accompanying drawings in which:

FIG. 1 illustrates a no-dial cell phone interviewing system.

FIG. 2 illustrates a client/user interface in more detail.

FIG. 3 illustrates a survey campaign design and creation module.

FIG. 4 illustrates an incentive module in more detail.

FIG. 5 illustrates a first round distribution module in more detail.

FIG. 6 illustrates a second round distribution module in more detail.

FIG. 7 illustrates a sample user device interface.

FIG. 8 illustrates a real-time dynamic distribution adjustment module in more detail.

FIG. 9 illustrates a client data collection and presentation module in more detail.

FIG. 10 illustrates a privacy protection module in more detail.

### DETAILED DESCRIPTION

It has been discovered that, as more people become unreachable via a land-line phone based on address, it is becoming extremely difficult to conduct certain types of surveys. Furthermore, the groups of people who are considered to live in cell phone only (CPO) and cell phone mostly (CPM) households represent disproportionately large percentages of several desirable demographic groups or frames. The inability to include these desirable groups in research can reduce the quality or even invalidate the results of the research.

By way of several non-limiting embodiments, this disclosure describes a no-dial cell phone interviewing system and method. More particularly, a system and method of conducting surveys with wireless and other devices using collected demographic information is described herein.

The no-dial cell phone interviewing system described herein relates to a survey system that is not conventional. That is, the particular problems associated with a conventional dial system are avoided. In the no-dial cell phone interviewing system described herein, some embodiments describe an initiated telephone call (e.g., a dialed telephone number). In the no-dial cell phone interviewing system, the initiation of a call involves a higher likelihood of successful completion of the call than in a conventional system. Other embodiments of the no-dial cell phone interviewing system involve a person-to-person or person-to-machine communication path that is instantiated electronically without a telephone number dialed at all, e.g., a VOIP path or other IP based path.

In the embodiments described herein, a cell phone may broadly be identified as a mobile device. A mobile device is often used for voice and data communications on a cellular or other like network. A non-limiting collection of mobile devices includes such devices as mobile telephones and laptop computers. Personal media players (PMP's), personal digital assistants (PDA's), handheld personal computers (HPC's), smart phones, tablets, and the like can also be considered mobile devices.

According to one embodiment, a mobile device has a central processing unit (CPU), a wireless transceiver, and a display. A memory has software, which is executable by the CPU. The software is operable to take direction in response to commands from a server wirelessly communicated to the mobile computing device through the wireless transceiver.

Often, a mobile device is associated with a particular user of the mobile device. The users of mobile devices include individuals and other computing devices. The mobile devices and users of the mobile devices may interchangeably be referenced herein as users, mobile devices, cell phones, and any combination of same or similar words.

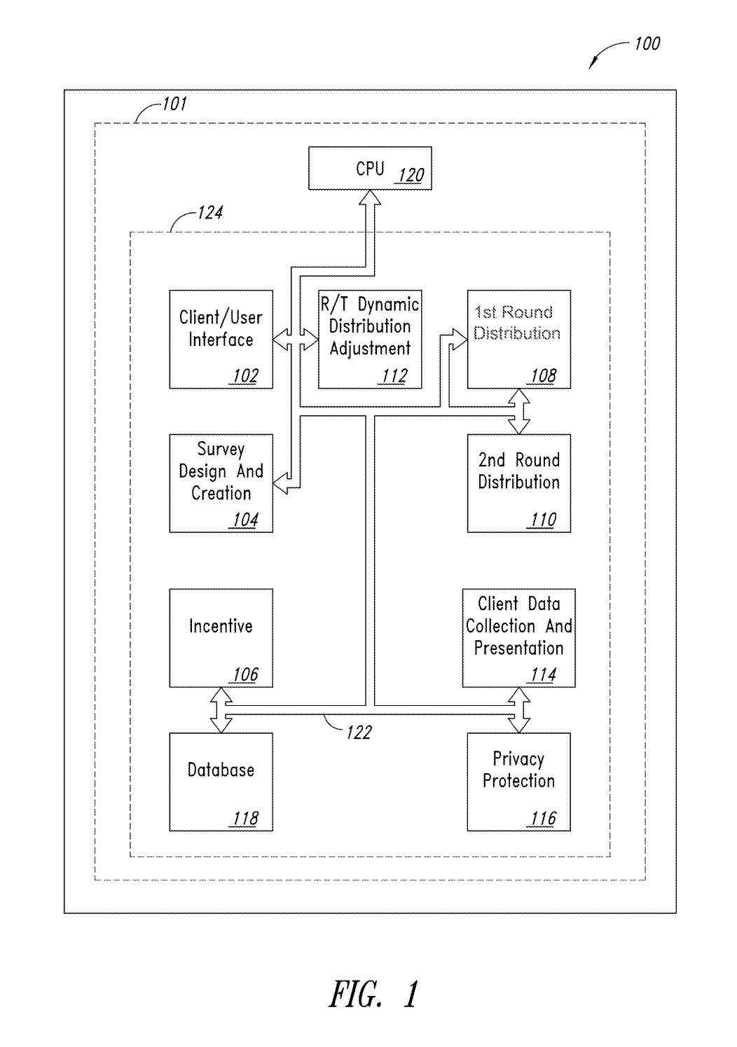

FIG. 1 illustrates a no-dial cell phone interviewing system 100. In some cases, the no-dial cell phone interviewing system 100 is wholly or partly embodied in a server 101. A client/user interface 102 is used to accept input data from a survey commissioning client and further used to output data to the survey commissioning client. The client user/interface 102 may be further used to accept input data from a survey taking user and output data to the survey taking user.

A survey campaign design and creation module 104 is used to facilitate the creation of a user survey, and an incentive module 106 is used to create, track, distribute, and otherwise manage user survey incentives (e.g., song downloads, software applications, gaming credits, or other electronically deliverable objects of value). A first round distribution module 108 is used to distribute phase one surveys to prospective survey taking users, and a second round distribution module 110 distributes phase two surveys to survey taking users that have qualified and accepted participation in the phase two survey.

A real-time dynamic distribution adjustment module 112 monitors the delivery and completion of phase one surveys in preparation for distribution of phase two surveys. A client data collection and presentation module 114 prepares and analyzes collected data for presentation. In some embodiments, a particular privacy protection module 116 functions to securely collect and utilize private data.

In the no-dial cell phone interviewing system 100, additional hardware and software components may be included. For example, data from the described modules may be stored in a database 118. A central processing unit 120 may control the operation of the no-dial cell phone interviewing system 100. One or more buses 122 may be discretely or virtually defined to enable communication of control or data information between modules.

In some cases, one or more modules in the no-dial cell phone interviewing system 100, wholly or in part, may reside as software and/or data in memory, illustrated, for example, as memory 124. Memory 124 may be a non-transitory computer-readable storage medium and may include one or more particular devices operating cooperatively or separately in one or more systems. Memory 124 may be recognized by those skilled in the art as any media bearing information that is capable of being distributed as a program and/or data product in a variety of forms, and that an illustrative embodiment applies equally regardless of the particular type of signal bearing media used to actually carry out the distribution. Examples of memory 124 include, but are not limited to, the following: recordable type media such as RAM, ROM, floppy disks, hard disk drives, CD ROMs, digital tape, and computer memory; and transmission type media such as digital and analog communication links using TDM or IP based communication links (e.g., packet links), or the like.

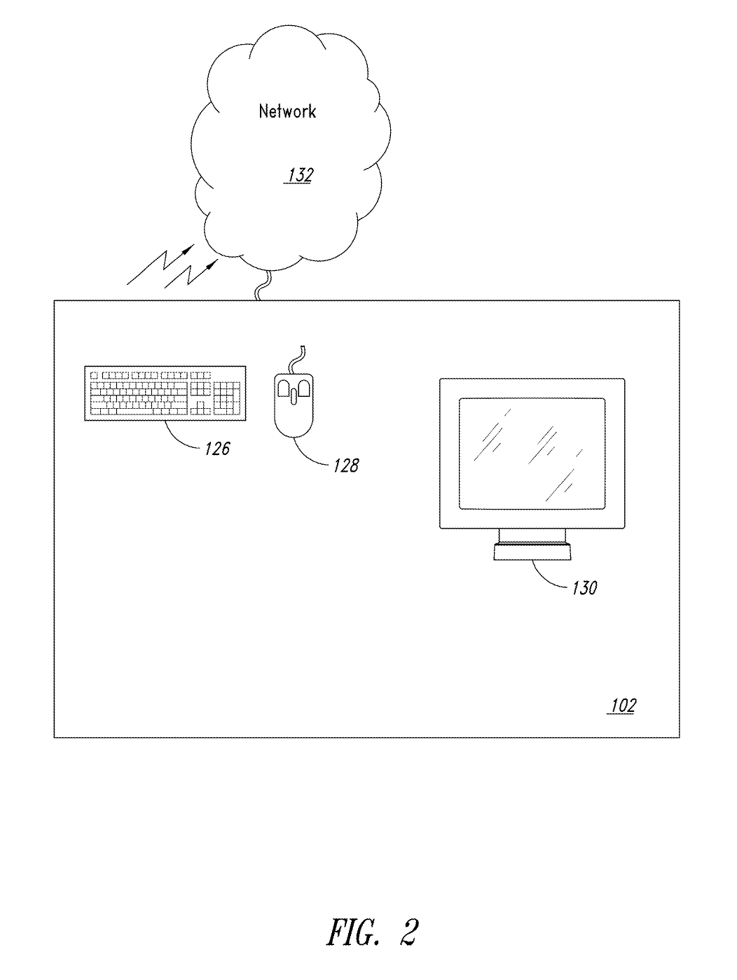

FIG. 2 illustrates a client/user interface 102 in more detail. The client/user interface 102 module may include hardware, software instructions, and software data that operate alone or in cooperation. For example, in one operation, the client/user interface 102 includes a keyboard 126 and mouse 128 or other human interface device (HID) for inputting control or data information into the no-dial cell phone interviewing system 100. In some embodiments, one or more display devices 130 present information from the no-dial cell phone interviewing system 100. Client/user interface 102 may also include wired or wireless connections to an electronic network 132 for communicating control or data information with the no-dial cell phone interviewing system 100.

In some embodiments, a client selects survey options and provides data to the no-dial cell phone interviewing system 100. This could be done directly or indirectly such as via a client facing website that has the capability to receive information that the client might upload. Alternatively, the client could work directly with a human or electronic representative to discuss a particular survey project and relay the relevant data to the no-dial cell phone interviewing system 100.

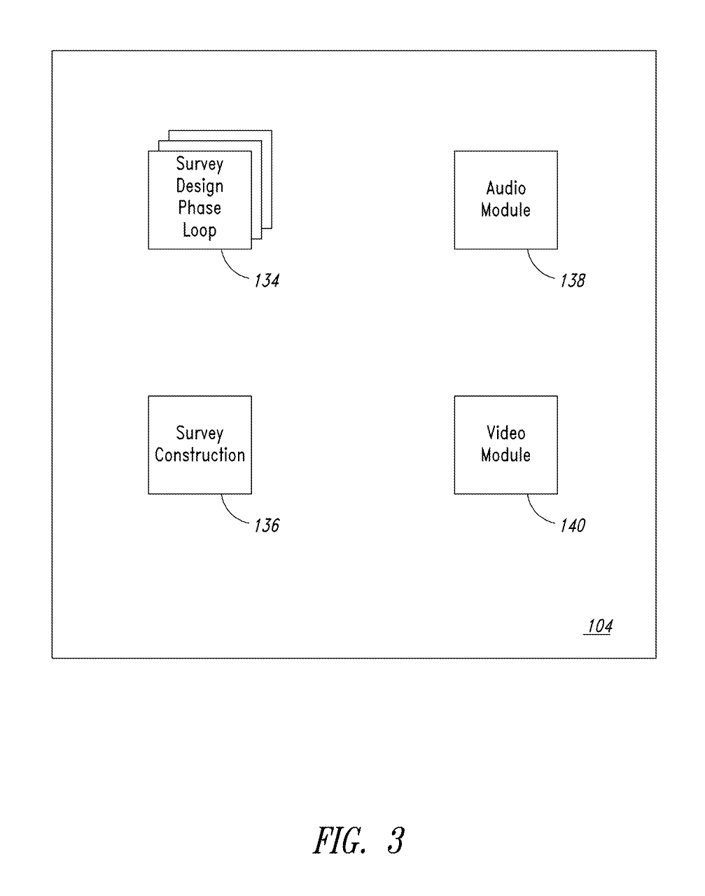

FIG. 3 illustrates a survey campaign design and creation module 104. In some embodiments of the no-dial cell phone interviewing system 100, the survey campaign design and creation module 104 constructs one or more survey phases and variants for use within the system with a survey design module 134 and a survey construction module 136. The creation of the survey may require multiple interactions with the survey commissioning client. Modules such as an audio module 138 and a video module 140 may be employed to help design and construct the survey. For example, in cases where pre-recorded interviewer questions and additional question details are required, multiple interactions with the client may facilitate the creation of some or all audio or other files required for the project.

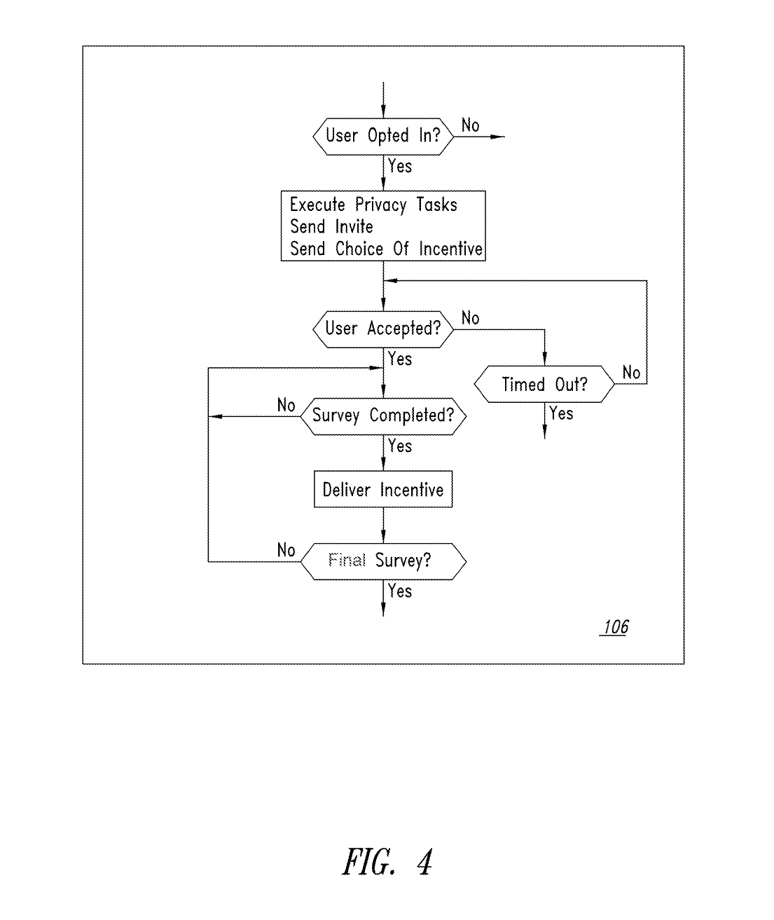

FIG. 4 illustrates an incentive module 106 in more detail. Using the client's frame, prospective and/or actual survey-taking users of the no-dial cell phone interviewing system 100 who have opted to receive these types of surveys are selected for distribution of survey invitations.

In some cases, the initial invitation can include a standard incentive. The user may decide to take the initial survey, decline, or ignore the survey until it expires. The user may potentially commence the survey, but for any number of reasons decide not to complete the survey. In one embodiment, the user will only receive the reward if they complete the initial survey. This would be considered an incentive within the industry, as it provides motivation to take the survey.

In some embodiments, the technique of providing incentives includes some of the characteristics of a pre-incentive. For example, the particular incentives of the no-dial cell phone interviewing system 100 may have a near instantaneous delivery. That is, the incentive may be delivered based on an indication from the data collection and presentation module that the survey has been completed. In addition, the use of the no-dial cell phone interviewing system 100 may provide incentives that operate to protect the user's anonymity.

The incentive module 106 of the no-dial cell phone interviewing system 100 may be implemented such that the user does not have to provide personal information in order to receive the incentive typically through postal or electronic mail. Receiving an incentive via postal or electronic mail may be undesirable for two reasons. Firstly, there is a delay between the action of taking the survey, and the realization of the incentive. The respondent is not guaranteed that the incentive will ever be delivered, or that it will be as described. Secondly, users may feel uncomfortable about or be unable to provide personal contact information. Thus, it can be seen that the incentive module may reduce the refusal or non response rate which could otherwise introduce a bias into the results of the research.

In another possible implementation the user could receive a true pre-incentive simply for viewing the description of the survey and regardless of their decision to complete the survey. By implementing the incentive module 106 in the no-dial cell phone interviewing system 100, it is not necessary to provide these types of pre-incentives as an enclosure with a mailed survey invitation. That is, added printing and postal costs in addition to requiring a mailing address for the potential user are avoided. Instead, using the incentive module, pre-incentives could be delivered instantly.

Within FIG. 4, particular execution of software instructions are illustrated. The instructions may be stored in the memory 124 and executed by the CPU 120 of a cell phone interviewing system 100. The instructions carry out the functions of the incentive module 106. Within the incentive module 106, the interviewing system 100 has contacted a particular user via the user's mobile device. In an initial contact, the interviewing system 100 has provided an opportunity for the user to opt in to the system 100. If the user does not opt in, then processing within the incentive module 106 ends. Alternatively, if the user has opted in, then processing in the incentive module continues.

Upon opting in, the cell phone interviewing system 100 communicates with a mobile device that is controllable by a prospective survey taker. One or more privacy tasks are executed. The privacy tasks may include identifying the prospective survey taker by name, e-mail address, telephone number, or by some other manner. The identification of the prospective user is suitable to uniquely identify one survey taker from another survey taker even if the two survey takers are both using the same mobile device. In other cases, the cell phone interviewing system 100 does not personally identify a prospective survey taker. That is, the interviewing system 100 does not receive the information sufficient to personally identify a prospective survey taker. Instead, the interviewing system 100 may only identify a particular mobile device. For example, the interviewing system may receive a Unique User Identifier (UUID). As another example, the interviewing system 100 may receive A Mobile Identification Number (MIN). Other mechanisms to identify a particular mobile device while a user that controls the mobile device remains anonymous may be employed.

This cell phone interviewing system 100 is then configured to send an invitation to a prospective survey taker that controls the mobile device. The invitation permits the prospective survey taker to decide whether or not to receive one survey, multiple surveys, surveys related to particular subjects, surveys offered only on particular days or within particular time windows, or according to other parameters.

The cell phone interviewing system 100 is configured to send an incentive to the prospective survey taker via the mobile device. In some cases, the cell phone interviewing system 100 may have a particular incentive hardcoded for delivery. In other cases, the interviewing system 100 may provide a plurality of choices of incentives to the prospective survey taker. In such cases, the prospective survey taker may choose an incentive immediately, or the prospective survey taker may decide on a particular incentive at a later time.

If the user has accepted an invitation to take a survey, processing in the incentive module 106 continues. If the user has not accepted an invitation to take a survey, then a certain amount of time is permitted to elapse. Before the certain amount of time has expired, the incentive module 106 will wait for the user to provide a response. If the user chooses not to accept a survey, or the certain amount of time elapses, then processing of the incentive module 106 ends.

The user then takes the survey, which is delivered by this cell phone interviewing system 100. After completion of the survey, the incentive module 106 delivers the incentive. In some cases, if survey responses are not received, the process of the user taking the survey repeats. In other cases upon completion of a survey, this cell phone interviewing system 100 will find a new survey for presentation to the user. In other cases, processing in the incentive module 106 ends.

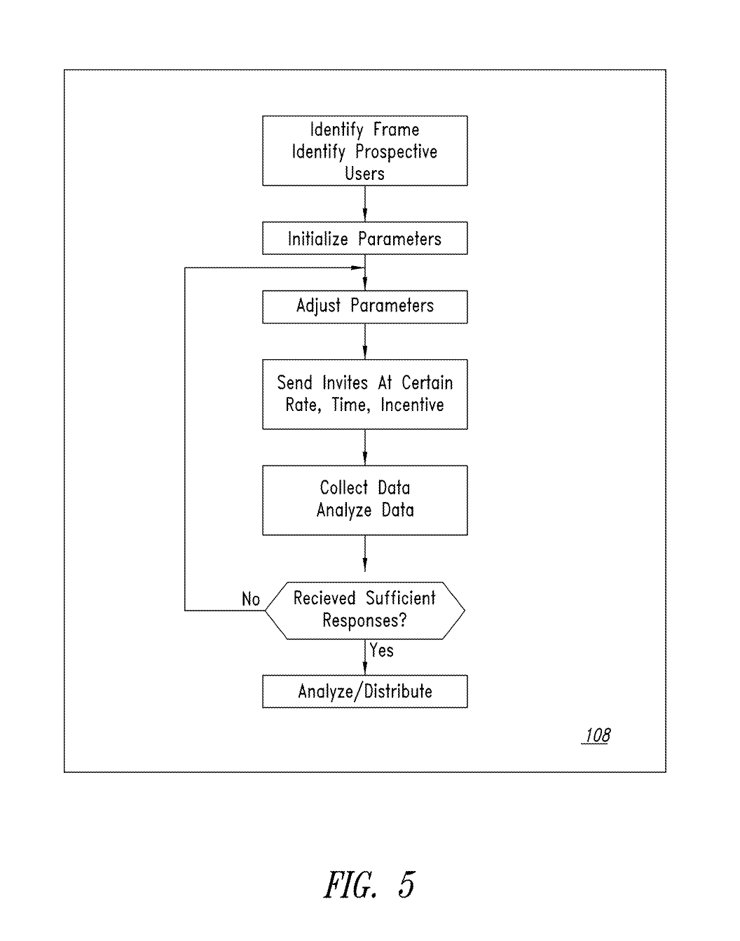

FIG. 5 illustrates a first round distribution module 108 in more detail. The first round distribution module may include dedicated or shared hardware and/or software. The server 101, via the first round distribution module 108, distributes individual survey invitations to users at a specific rate.

In some embodiments, the first round distribution module 108 can be used to strategically distribute the invitations in such a manner as to target selected users who, as determined through particular analytics, are likely to view and or respond to the invitation rapidly. In some cases, decisions can be made by the first round distribution module 108 based on patterns detected in the user's response history, preferences selected by the user, true user location which is based on an assumption derived from a telephone area code or prefix, a global positioning system (GPS) data point, or any number of other methods.

The first round distribution module 108 may be used to avoid particular practices that some users may not like. For example, via the first round distribution module 108, contacts that are incapable of determining if an invitation call will occur at the respondent's dinner time, afternoon commute, or other inconvenient time may be avoided. By collecting and analyzing particular usage information, the first round distribution module 108 is able to timely and conveniently deliver the invitations in a manner that increases the likelihood of participation.

The first round distribution module 108 may reduce the time taken by the no-dial cell phone interviewing system 100 to obtain an acceptable number of responses. Further, the first round distribution module 108 may improve the quality of other metrics collected by the no-dial cell phone interviewing system 100.

In other embodiments, the distribution, and resulting viewings, refusals, and survey completions may all be monitored by the first round distribution module 108. Such monitoring may help to determine improved methods for continued distribution of the initial phase invitations.

In some embodiments, the acceptance and refusal rates may also be monitored based on specific demographic and qualifying factors relevant to the client's frame. In such cases, the first round distribution module 108 may be capable of making adjustments to compensate for under representations of any group that may emerge. These adjustments can be made in real time.

Use of the first round distribution module 108 may provide many benefits. For example, the first round distribution module 108 may have the ability to constantly adjust distribution in order to meet the frame parameters. Such adjustment by the first round distribution module 108 may reduce the need to over sample and subsequently weed out excessive responses in such a way as to meet the desired ratios of user sub classifications. That is, in embodiments of the first round distribution module 108, the monitoring and adjustment capabilities may reduce cost as well as time associated with oversampling.

An additional benefit of the first round distribution module 108 technology is the quality of information collected during this phase. For example, via the data produced by the first round distribution module 108, researchers may better understand non response or refusals. One reason that the first round distribution module 108 may provide such benefits is that the first round distribution module 108 has an improved certainty that a phone number called is truly active or an address is occupied.

Still other benefits of the first round distribution module 108 may be recognized. For example, a problem where phone numbers are identified by the phone company as disconnected when dialed may generally be avoided. Postal mailings that are undeliverable and otherwise returned to the researchers may be avoided. Further, the first round distribution module 108 may improve efficiency by avoiding problems where emails may bounce or inconsistently provide read receipts or other delivery information.

In some embodiments, the first round distribution module 108 is configured to automatically compile and provide descriptive data. That is, in some embodiments, the first round distribution module 108 allows detailed reporting of what happens once an invitation is delivered. Reporting can include date, time, global positioning system (GPS) location, duration, and user decision information for many events including delivery, viewing of invitation, refusal or commencement, completion, and other factors surrounding the survey. In some cases, the first round distribution module 108 analyzes and/or configures the information to be associated with the user's demographic information. In such cases, the survey commissioning client may receive valuable information that was previously unavailable.

In some cases, the first round distribution module 108 further avoids the problem of determining why a particular phone number is never answered, or who if anyone listens to a voice message left on an answering machine. The first round distribution module 108 gathers and analyzes sufficient information to answer such questions in great detail. Accordingly, information that can be derived by the first round distribution module 108 could be employed by researchers to gain greater understanding on factors that result in an unanswered invitation. Such understanding may help researchers to determine demographic groups that are over represented in specific categories of non respondents for example.

One advantage to the first round distribution module 108 is the ability to deliver an invitation directly to a specific individual. That is, the problem of a telephone call to a land line that may be answered by any number of individuals within a household is avoided.

Another advantage of the first round distribution module 108 is that the module 108 avoids repeated calls to a single household where one or more refusals are followed by an acceptance simply based on the household member who answers a particular call. Similarly, the first round distribution module 108 avoids a problem with postal mailings where it is unknown if all members of a household view the mailed invitation or if one or more individuals are responsible for screening mail. In such situations, the case wherein a likely user could become a non responder without ever having seen the invitation is avoided.

The first round distribution module 108 enables reaching a specific individual user consistently. The users of the no-dial cell phone interviewing system 100 are determined to be willing to participate in some or all types of research surveys based on their previous usage of the no-dial cell phone interviewing system 100 and/or user settings. When users view invitations, the first round distribution module 108 determines that the user has made a conscious decision to view the invitation at a place and time that is convenient to them.

The invitation sent by the first round distribution module 108 is generally not vulnerable to loss due to factors of disorganization or acts of others. For example, using the first round distribution module 108 avoids the problem of other household members deleting voicemails or throwing away mail.

Additionally, the first round distribution module 108 avoids the problem of email invitations, which are respondent specific, yet can become lost in a clutter of other email messages of mixed purpose and importance. By contrast, the first round distribution module 108 may be specific to the invitation function and therefore reduces cases of clutter or inadvertent loss. The first round distribution module 108 may be self cleaning and organizing to further prevent confusion that could result in non response.

One embodiment of the first round distribution module 108 is illustrated in FIG. 5. Within the first round distribution module 108, a particular frame (e.g., demographic grouping) is identified, and prospective users (e.g., survey takers) are identified. A set of parameters are initialized. The parameters may include initialization of variables, counters, timers, data sets, and the like. With respect to the particular frame and pool of prospective users, parameters of the first round distribution module 108 are adjusted. In some embodiments, the adjustments are made by a real-time dynamic distribution adjustment module 112, which may be integrated with the first round distribution module 108 or maybe separately configured.

Survey invitations are sent to particular mobile devices that are within the frame. The invitations may be sent to a mobile device control by an anonymous prospective survey taker, or the invitations may be sent to known prospective survey takers via an associated mobile device. The invitations may be sent at a particular rate, such as 10 or 1000 per hour, so that the pool of survey takers is controlled. The rate may be varied. The rate may be set based on the quantity of incentives that are available to be distributed. In addition to a particular rate, survey invitations may be sent out according to other parameters such as day of the week, time, incentive offered, or other factors.

As survey takers participate in respond to survey questions, data is collected by the first round distribution module 108 and analyze.

If an insufficient number of responses are received, parameters may be further adjusted and additional invitations may be distributed. In some cases the number of sufficient responses may be based on the number of surveys distributed. Surveys may be time limited by the first round distribution module 108. That is if they distributed survey is not taken within a certain time. The survey will expire. In such cases, the prospective survey taker may or may not be entitled to an incentive.

After a sufficient number of responses have been received by the first-round distribution module 108, the survey results are analyzed and distributed, and processing ends.

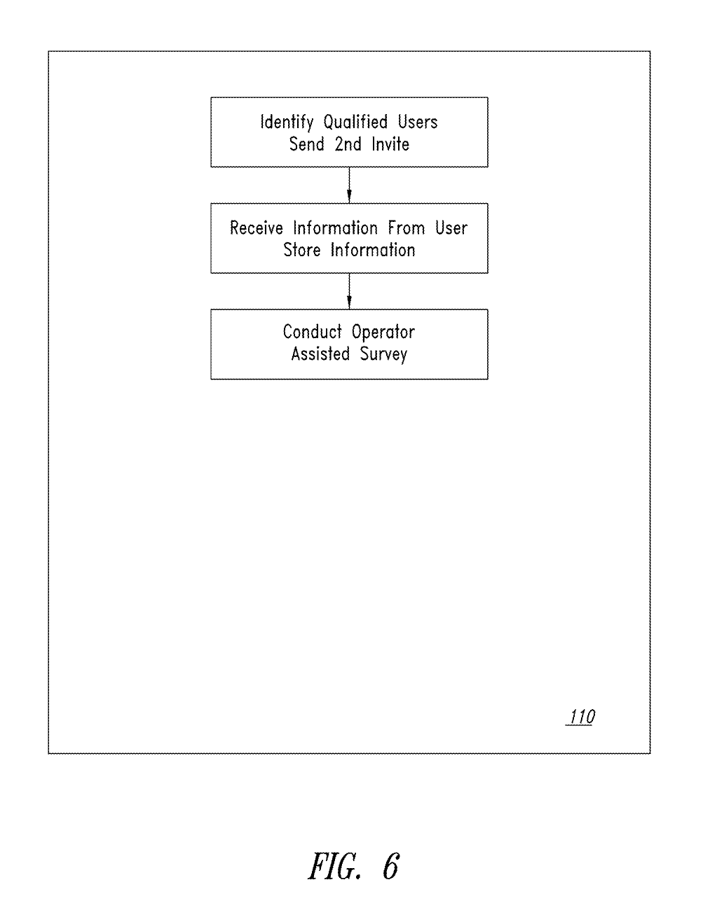

FIG. 6 illustrates a second round distribution module 110 in more detail. Users who have qualified for, and accepted participation in the voice survey (second round) are sent a second survey notification. These notifications can be distributed by the second round distribution module 110 in much the same manner as in the first round or in a different manner.

In the case where a live call center operator is utilized either exclusively, in part, or as an option, the distribution of invitations may have the additional goal of efficient operator usage. With one goal of reducing peak loading of operators as well as wait time for users who have called in, the distribution of second round invitations may be adjusted in part by call center loading and operating hours.

The adjustments to second round invitations may be made possible by offering connections to the call center directly from the user's device. This is one technique that allows the no-dial cell phone interviewing system 100 to monitor call loading and determine call durations in real time.

In an implementation where the call center will be calling the user, the user may be allowed to schedule a time or time window for the call. In addition to passing the offered call times and information to the call center, second round distribution module 110 of the no-dial cell phone interviewing system 100 may maintain a database of scheduled call times and other factors, which may be done in real time. This dynamic database could allow second round invitations to present users with available appointment windows that reflect the available call center capacity at the time the user selects their time window. In this way users would not be presented with options to book operator interviews during a time that operators might not be available to call due to overbooking.

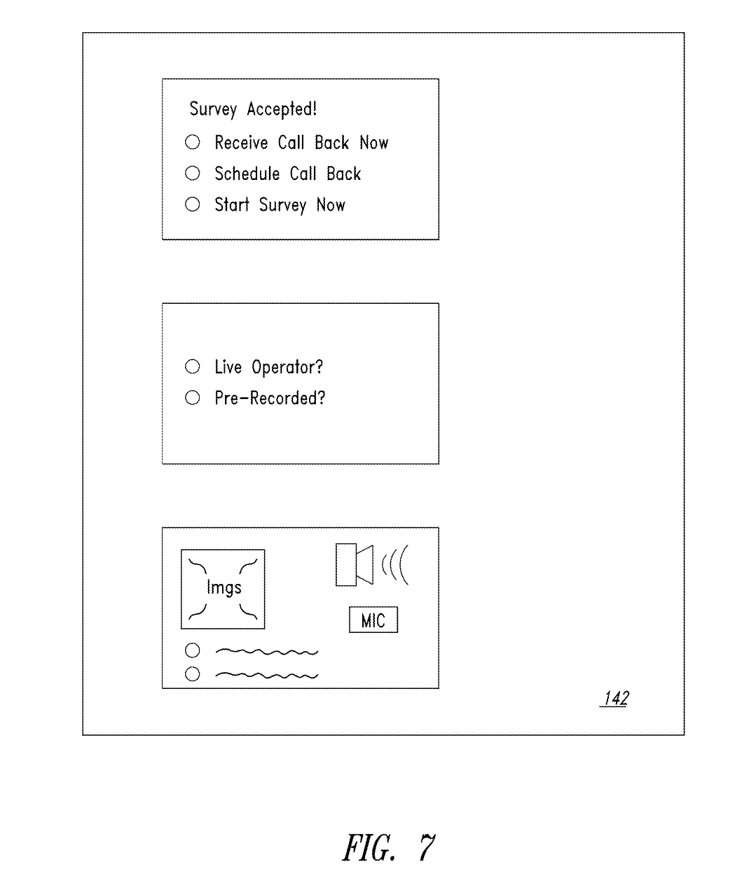

FIG. 7 illustrates a sample user device interface 142. The operations of the second round distribution module 110 may cause the presentation of such interface on a user device. For example, when the user chooses to begin the second round survey using their device, a user interface 142 may present the user with the available options to complete the survey.

Optional components of the user device interface 142 may include calling an operator, self administering a voice survey comprised of recorded operator questions and which records the user's responses, or scheduling a time or time window to receive a call from an operator. Additional optional components of the user device interface 142 may include other options or a combination of multiple methods.

In some cases, the second round distribution module 110 could deliver data including any images or audio files to the user's device prior to the user having viewed the invitation details. Once the user chooses, via the user device interface 142, to view the survey details the options available to them could be presented, and the user could immediately select and schedule or commence the survey through the method of their choice.

In some embodiments, surveys that do not require contact with a live operator can be started regardless of the device's ability to communicate with the no-dial cell phone interviewing system 100.

The cooperative functions provided by the second round distribution module 110 and the user device interface 142 provide many benefits. For example, in some cases, the second round distribution module 110 permits contacts where operator assisted interviewing is knowingly and conveniently initiated by the operator.

In one example, the cooperative functions provided by the second round distribution module 110 and the user device interface 142 may help to avoid a particular situation. The particular situation avoided is one in which an operator calls the potential respondent at a time which may or may not be convenient to the respondent. If the respondent is willing, yet unable to take the survey at the time of the call the operator can attempt to schedule a call back. Due to the loading of the call centers with outbound calls attempting to reach respondents, and unpredictable success in commencing interviews, as well as calls required to validate telephone numbers it is difficult in the particular situation for operators to schedule accurate call back times. Additionally, call centers are typically not structured to accept inbound calls wholly or partly due to the excessive burdens placed on the operators.

The cooperative use of the first round distribution module 108 and the second round distribution module 110 may reduce the workload of call center operators through many of the different functions it performs, or renders unnecessary. One example would be the elimination of the need to collect contact information for the purpose of distributing incentives to respondents. Another factor resulting from this two stage approach is the removal of the need to prequalify participants.

For example, the cooperative use of the first round distribution module 108 and the second round distribution module 110 may save time and other resources. In one case, it possible to ask questions that do not use an operator as a part of stage one. In another case, it is possible to ask questions as part of a pre or post stage two operator interview question process via self administered questions on the device. The reduction in the number of questions that are operator administered, along with the associated coding time, work to reduce per interview operator hours. Accordingly, the cooperative use of the first round distribution module 108 and the second round distribution module 110 can be a source of significant cost savings to the survey commissioning client.

The second round distribution module 110 may be used with an operator pool that is directed by the no-dial cell phone interviewing system 100. Alternatively, the second round distribution module 110 may provide information to a different pool of operators, e.g., a third party provider's operators.

In some cases, the operators could be under the employ of the survey commissioning client. In some cases, the survey commissioning client could be a third party call center who is utilizing the no-dial cell phone interviewing system 100 to collect data for an end data using client that may or may not be known.

One implementation of the no-dial cell phone interviewing system 100 could facilitate interviews administered by operators from any group in a de-centralized manner. Particular no-dial cell phone interviewing system 100 servers could allow operators to accept calls from any location in the world. Particular no-dial cell phone interviewing system 100 servers could create the ability for operators to remotely log into the servers to access information required for conducting interviews. Optionally, the no-dial cell phone interviewing system 100 may be used to allow operators to log into or out of the operator pool based on their own specific schedule requirements.

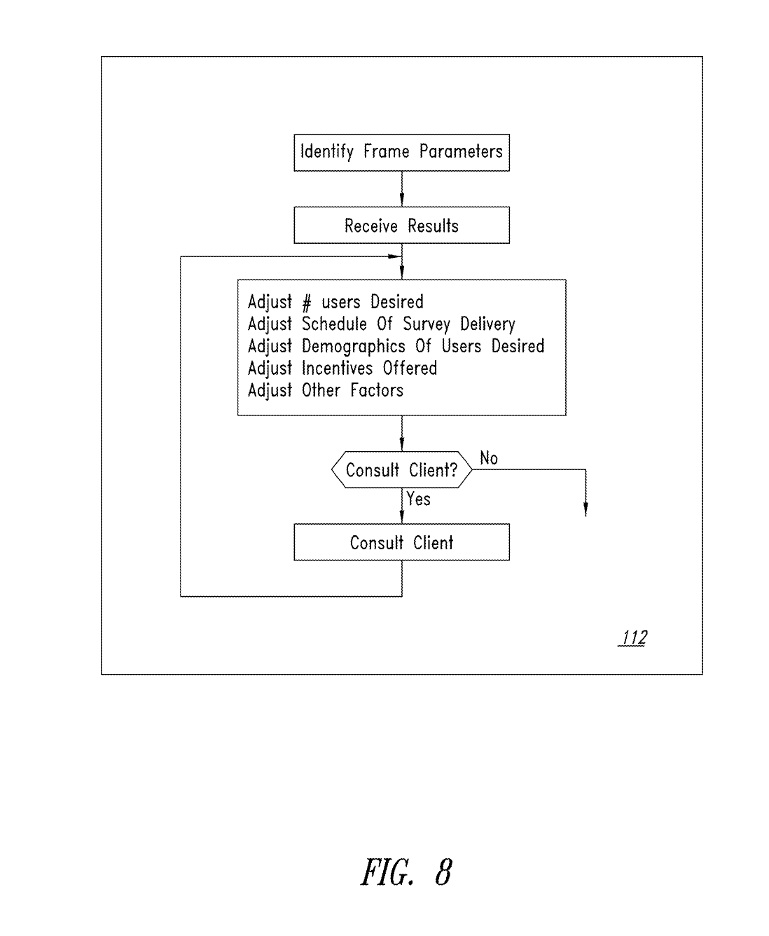

FIG. 8 illustrates a real-time dynamic distribution adjustment module 112 in more detail. In one aspect, the real-time dynamic distribution adjustment module 112 operates concurrently with the first round distribution module 108. In one aspect, the real-time dynamic distribution adjustment module 112 is integrated with the first round distribution module 108.

The first round distribution module 108 continues to distribute phase one invitations until an acceptable or “full” level of distribution is realized. Full distribution of the first phase is achieved by monitoring completion, acceptance, and refusal of participation in the first phase, as well as qualification and willingness to participate in the second phase of research. Distribution by the first round distribution module 108 continues until the frame is met.

Operation of the real-time dynamic distribution adjustment module 112 may include consultation with the survey commissioning client. Operation of the real-time dynamic distribution adjustment module 112 may also include a review of results at the first round distribution phase. In addition, operation of the real-time dynamic distribution adjustment module 112 may also include decisions to commence additional distributions in order to compensate for any factors that may affect the research.

This real-time dynamic distribution adjustment module 112 process continues until the group of users satisfies the survey commissioning client's criteria. Additionally, operations of the real-time dynamic distribution adjustment module 112 can be re started at any time during or after the second round distribution so as to adjust for realized response rates in that phase. The real-time dynamic distribution adjustment module 112 may provide continual efforts to provide relevant and useable results to the survey commissioning client.

The real-time dynamic distribution adjustment module 112 provides many benefits in the no-dial cell phone interviewing system 100. For example, the real-time dynamic distribution adjustment module 112 is capable of providing significantly more data to be used in evaluation. Additionally the data is provided rapidly, which allows for changes to be implemented nearly instantly. Providing more data rapidly may be important for the underlying survey research as related to factors that are changing.

For example, in one hypothetical case, research is conducted on spring fashion. Using the no-dial cell phone interviewing system 100, and in particular, using the real-time dynamic distribution adjustment module 112, only a small amount of time may be taken to evaluate response factors such as demographics. The operations of the real-time dynamic distribution adjustment module 112 facilitate rapid invitation distributions instead of delaying them to another season where such delay may result in a different context which might alter respondent's views.

One embodiment of the real-time dynamic distribution adjustment module 112 is illustrated in FIG. 8. The module 108 may be integrated as part of a first round distribution module 108, or the module 108 may be separately configured. Processing in the module 108 begins with an identification of frame parameters. As results are received, the particular results are analyzed. The analysis of the parameters may occur one time, or the analysis process may be iterative. That is, as results are analyzed, a client (e.g., the entity who has commissioned a survey), may be consulted to review the received results.

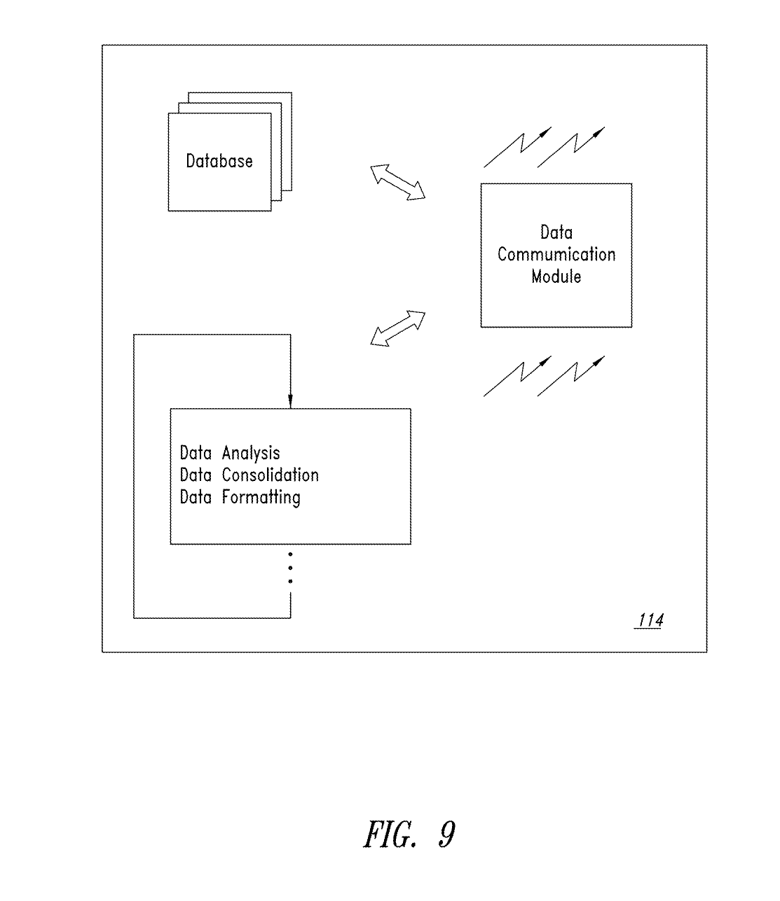

In the embodiment of FIG. 9, several parameters may be analyzed and adjusted. The parameters illustrated in FIG. 9 are provided merely as examples, and other parameters may also be included. In the embodiment a number of users (e.g., survey takers) is one parameter, a survey delivery schedule is another parameter, and the particular demographics or other criteria of the desired frame is another parameter. A particular incentive or plurality of incentives that are offered are still other parameters, and other factors may also be parameters.

FIG. 9 illustrates a client data collection and presentation module 114 in more detail. The client data collection and presentation module 114 may include hardware and software individually or in part. Further, the client data collection and presentation module 114 may reside wholly in a client device or may have hardware and software distributed amongst two or more devices.

Via the client data collection and presentation module 114, results of the survey as well as all other data logged by the system may be transmitted to the server or other module of the no-dial cell phone interviewing system 100. The results that are collected on a user device may be collected and stored regardless of network or other connectivity to a no-dial cell phone interviewing system 100 server. For example, this may be implemented in a manner that allows users to respond to one or more surveys on their device even during extended periods of non-connectivity with a server.

Once a survey is completed, and/or connection with a no-dial cell phone interviewing system 100 server is established, the data collected on the device may be transmitted to the server for further processing. In the case of a multistage approach, e.g., the phase one and phase two approach described herein, portions of data related to a single survey may be transmitted to the servers in multiple phases. These transmissions may or may not directly relate to the users progress through the survey(s).

According to one embodiment, all of the data associated with a client's survey project will have been collected on the no-dial cell phone interviewing system 100 server. The data may be combined with other information as one part of the process in preparing a completed result set to be provided to the survey commissioning client. This result set could be provided to the survey commissioning client in various states.

In some cases the results could be presented after the data is analyzed and processed in such a manner as to completely document the findings of the survey. In other cases some or all of the data could be provided to the survey commissioning client for their review.

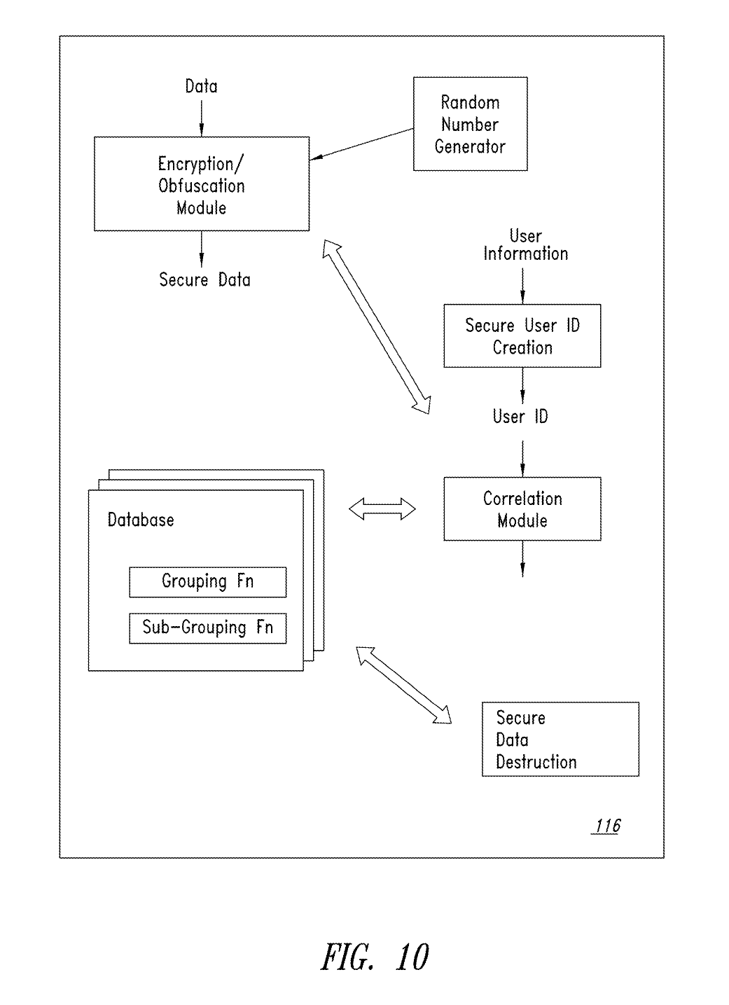

FIG. 10 illustrates a privacy protection module 116 in more detail. Users of the no-dial cell phone interviewing system 100 may or may not desire a specific level of anonymity. Their preferences may be captured as part of their user profile within the no-dial cell phone interviewing system 100.

In some embodiments, the user profile could be accessed from a user device for the purpose of initial setup as well as periodic alterations based on the user's desires. Certain studies or research projects offered to users on behalf of survey commissioning clients may request the user to disclose their identity to the client through self administered questions or as a part of an operator interview. Invitations to participate in such surveys could be sent only to users willing to provide information equal to or in excess of that requested by the particular study. Alternatively, users could be notified on the invitation description page that there will be personal information collected as a part of the study.

Via the privacy protection module 116, the nature of the information, the entities to whom the information will be disclosed, and the protected or unprotected status as required or optional could be disclosed in this description page. Such disclosure provides an opportunity for the user to decide if they will participate in a particular survey. Via the privacy protection module 116, the user is given an opportunity to weigh the particular data requests prior to making their decision.

The no-dial cell phone interviewing system 100, as a part of its process, may collect and compile information on its users. The information collected may be used for business purposes, which may include the marketing of the user base to survey commissioning clients or selection of individuals to whom a specific study will be distributed.

In a case where personal information that may compromise the user's anonymity would be collected as a part of a study, the privacy protection module 116 could temporarily use the information and then dispose of the information. In another case, the privacy protection module 116 may act solely to pass the information to the survey commissioning client who has disclosed to the user that they will collect the personal information.

In such cases that the privacy protection module 116 might, through its functions, provide personal information to a survey commissioning client, the privacy protection module 116 may utilize particular technologies to mask the personally identifying information from the survey commissioning client.

Such cases could include an instance where a user is presented with an option to contact an operator for the purpose of an operator administered survey. The second round distribution module 110 may provide a dial in number for the user to dial when calling the operator. The number could be utilized from any telephone line, and the privacy protection module 116 would re-direct the call to the operator in such a way as to mask or remove the user's caller id information.

Another implementation of this technique to protect user caller id information from disclosure could involve a button or other user interface item on the user device that would connect the user to the operator. The connection could be made in many different ways including using telephone service available on the user device. In the case of a user device initiated telephone connection, the user's caller id information could be blocked from the call center by the privacy protection module 116.

In the case that the user desires to schedule a specific call back time for an inbound call from an operator there are multiple methods that the privacy protection module 116 might use to facilitate this connection without disclosing the user's telephone number to the call center. In one possible implementation the call center may be presented with an option for the operator to initiate a scheduled call by causing the no-dial cell phone interviewing system 100 server to send data to the user device. This data could cause the device to notify the user that the operator is ready for their interview.

In such a case, the user device might accomplish this in any number of ways including vibrating, making a sound, or displaying a message. These methods and or others may be used in combination or individually. The data sent to the device could include information necessary to allow the user to initiate the connection at the time of the notification, or for a time period thereafter. The time period allowed for response could be specific to a given study or call center or based on any number of factors. The notification could include the option to connect with the operator. It may also include options to reschedule the call due to an unforeseen conflict with the user's schedule, or to refuse to connect with the operator.

Some embodiments describe a system and method to reach individuals who fall within the frame of a project without dialing telephone numbers that may or may not currently be in service. For example, one embodiment involves sending initial, self-administered qualifying surveys to users based on a database of demographic information. Another embodiment may involve other factors useful in identifying specific users that are likely to meet a client's research needs.

In some embodiments, users to whom the initial survey is sent may be preselected to fit the frame of the client's study. These initial qualifying surveys may include questions to help qualify the user for a complete survey, an additional survey, or some other survey. Users who complete these initial surveys may or may not be rewarded for their participation.

In one embodiment, after a self-administered initial survey phase has been completed, and if the responses have been adequate to qualify the user for the client's research, a subsequent invitation may be sent to the user to participate in a second phase of the survey process. This invitation could notify the user that the follow-up survey is to be an interview rather than a self administered survey. In some embodiments, the user is then offered multiple choices and soliciting a decision as to how they would desire to proceed.

Several embodiments provide different multiple choices for conducting the follow-up interviews. For example, some embodiments enable the user to select a call time or window during which the user would be willing to accept an interviewer's call. Other embodiments enable the user to initiate a call from within an application running on the user's mobile device. Another embodiment enables a user to view a telephone number they could use to call the interviewer center from their mobile device, fixed-point device, or an alternate telephone.

Additional embodiments may provide for the storage and delivery of interviewer's questions that have been pre recorded. These pre-recorded questions may be sent to the user's device in a similar manner to the distribution of other surveys. In such embodiments, the pre-recorded questions could then be listened to and answered, one at a time.

In some embodiments, where questions are pre-recorded, for example, the pre-recorded questions may enable a user interface on the device to start, stop, and replay an individual question until the user is prepared to answer. The user's answers could be recorded as audio files, and later returned to the survey's commissioning client for particular purposes such as coding.

In some embodiments, particular questions may have images or text displayed on the user's device as an accompaniment to the audio portion of the question.

In the case that the survey is conducted using pre-recorded audio files, a basic or standard audio file for each question could be included. After the user has listened to this file the user could be presented with several options. The user could choose to record their answer. If there was difficulty understanding the question, the user could choose to replay the question audio file. The user could also be given an option to hear a second audio file for the same question. This second file could be a more detailed and/or alternately worded version of the same question. The use of the second file provides one way of improving the ability for the user to understand and accurately answer the questions in much the same way that they would when talking to a live individual.

In some embodiments, information involving the user's use of the audio files and play-back features can be included in the data collected. Such information may be collected and/or processed and presented to the survey commissioning client.

In some cases, the second stage surveys could have added rewards, which may be of any type, and may also reflect the increased efforts on the part of the survey taker.

In some cases, users of the system could be presented with choices regarding which types of surveys they are willing to take. Users who have chosen not to be included in voice surveys would not receive the first portion of the survey. By not including users that have opted out of voice surveys, the non response rate of the survey results may be reduced.

User's who receive the first portion of the survey may be chosen in such a manner as to include a desired ratio of particular sub groups within the survey commissioning client's frame. In such embodiments, the selection of particular sub groups may aide in improving the quality of data produced for the survey commissioning client by avoiding results that are biased through over response of one or more sub groups.

For example, a situation of the case that 79% of the responses are from women may be avoided when the client's frame has been defined to contain 52% women. Efforts to correct these imbalances could be made as individuals qualify for the study and choose to participate. If one or more sub groups trends toward under representation, the remaining phase one invitations can be sent in such a manner as to correct for this imbalance in respondents. Data collected during this process can be used to further develop distribution techniques. Data collected during this process can be provided to the survey commissioning client as companion data to their research and could be used for multiple other purposes.

One benefit of the embodiments described herein is that rather than attempting to contact a person on the other end of a phone number, an embodiment of the present system allows contact with a specific user. In addition, embodiments of the present system are not affected by the changing of a user's phone number. Further, embodiments of the present system allow geographic targeting based on current, persistent, and or historical GPS location. Such embodiments do not rely on postal contact or invitations.

Such embodiments also provide other benefits. For example, the need for the interviewers or others to validate a list of phone numbers searching for disconnected numbers is reduced or even eliminated. In addition, the need to identify numbers that would skew the non response rate unnecessarily may also be reduced or eliminated.

Another benefit of the system and method described herein is that in some embodiments, operators may not need to make multiple calls to respondents and leave voice messages in the hopes of obtaining a completed response set. Instead, the embodiments permit a more efficient use of human and electronic resources by enabling the interviewers to focus their time on interviews in the case where a user is questioned live.

One more benefit of the system and method described herein relates to embodiments where the questions are sent as one or more audio file and the responses are recorded. In such cases, the collection of data is streamlined. The responses are discrete audio files and are associated with specific questions. Such embodiments allow for greater ease in coding the collected data. Operators could listen to the responses sorted by question rather than by respondent. For example, data may be presented in this manner to allow the operators to work more efficiently by coding same questions from multiple survey takers into a group rather than switching gears from one question to the next. In some embodiments, the survey and method described herein include collection, analysis, and distribution of such data. The data may be hosted and an interface may be created to permit remote access to the data.

Certain survey commissioning clients may wish to make subsequent contact with users who have previously participated in a survey. The no-dial cell phone interviewing system 100 has many methods that can make this possible with a higher success rate, reduced costs, reduced efforts, and improved timeliness.

Cases may exist where a survey commissioning client has a study that desires initial qualification as described herein with respect to the first round distribution module 108 for example. Such cases may also have a component requiring ongoing data collection from users. The ongoing contact may or may not follow a regular schedule, and may or may not be foreseen at the time of the initial study survey.

The privacy protection module 116 of the no-dial cell phone interviewing system 100 may simplify the ongoing data collection process. One method is made possible through user base tracking. For example, each user may select or otherwise be assigned an associated user ID. This ID is substantially unique to each user and is generally not associated with the user's name, address, telephone number, email address, or other selected private information. Accordingly, the user ID and other information associated with users of the no-dial cell phone interviewing system 100 does not contain personally identifying information.

In one embodiment, a user who establishes services on a specific device could migrate their service to a different device. Accordingly, the method of identifying users via a privacy protection module 116 administered user ID is not vulnerable to issues that inhibit future contact. A user who changes their phone number, moves, or changes email services can still be contacted for follow-up questioning.

Privacy protection module 116 administered user IDs allow a survey commissioning client to request distribution to a previous group of users at any later date. The no-dial cell phone interviewing system 100 maintains information on each user which may include historical information that may facilitate such a future distribution.

Alternatively, other features of the privacy protection module 116 may have features that allow users to group themselves into one or more sub sets of the user base. These sub sets or “GROUPS” allow users to receive surveys that are distributed to all or part of a GROUP they have opted to join.

In some embodiments, the GROUPS could be owned or otherwise controlled by survey commissioning clients that might be clubs, schools, associations, or other types of organizations that might wish to periodically receive input from some or all of their members.

In the case of a club or organization, a user might be provided with a GROUP name, and an accompanying password or other login credential. The login credential may or may not be substantially unique. In such cases, the user could then opt to join the GROUP using their device that has been established with the no-dial cell phone interviewing system 100.

In the case that the user/recipient of such a login credential is not currently registered with the no-dial cell phone interviewing system 100, the user may first enable a device to communicate with the no-dial cell phone interviewing system 100. During their setup, the user may or may not opt to participate in other surveys or GROUPS administered by the no-dial cell phone interviewing system 100. Instead, the user may opt to solely participate in the GROUP for which they were provided credentials.

In the case of a survey commissioning client that may wish to have ongoing contact with users who have participated in their survey, or in order to maintain contact for an extended study, the survey commissioning client's initial survey could include an invitation to join a GROUP specific to the survey they are currently taking. This process could also be performed by offering an option to join a GROUP for this purpose by way of an invitation at a later date.

Once the participants have joined the GROUP, the survey commissioning client can easily distribute subsequent questions to some or all of the members within the GROUP. Users of the no-dial cell phone interviewing system 100 who have established membership in one or more GROUPS may have various options available to them as a part of their user settings, which they can access on their device. Users could have an option to modify, suspend, or cancel their membership in any or all of the GROUPS to which they belong. In this manner users are provided easy means to opt out of future invitations to participate in surveys from a specific GROUP owner.

In FIG. 10, one embodiment of a privacy protection module 116 is illustrated. Within the module, particular software instructions and electronic circuits may work cooperatively to provide privacy protection to individual users of the no-dial cell phone interviewing system 100. A random number generator, for example, is used to seed an encryption/obfuscation module. Data that is passed through the encryption/obfuscation module is transformed into secure data. The secure data may be stored in a memory, such as memory 124, with a reduced concern that if the memory is accessed by an unauthorized party, the unauthorized party will be unable to learn the original data (e.g., privacy information).

Additional processing within the privacy protection module 116 receives and operates on user information. A unique user ID is created for each user of the no-dial cell phone interviewing system 100. The user ID may be passed through the encryption/obfuscation module in some embodiments. The user ID is correlated with a correlation module to particular entries in a database of the no-dial cell phone interviewing system 100. That is, particular entries in the database, which are specifically associated with the user ID, are created, read, written, and otherwise subject to processing. For example, grouping functions, sub-grouping functions, and other functions act on data within the database. The data that is operated on may be manipulated individually via the user ID, or the data may be operated on as part of a group.

In some embodiments, data is destroyed with with a secure data destruction module. The secure data destruction module may include transformation of the data before it is deleted, additional processing on the data to obscure its previous state, or the secure data destruction module may perform other techniques to delete the data.

In the preceding description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with register renaming systems, processors, and processor-based systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, e.g., “including, but not limited to.”

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The various embodiments described above can be implemented individually or combined to provide further embodiments. Any and all of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

I/we claim:

1. A mobile device interviewing system, comprising:
a computing server having a database;
an electronic user interface module directed by the server;
a campaign design and creation module configured to select a plurality of survey questions;
a first round distribution module configured to automatically distribute, via the electronic user interface, a first phase survey created by the campaign design and creation module to a plurality of mobile devices, each mobile device respectively controllable by a prospective survey taker;
a second round distribution module configured to automatically distribute a second phase survey to a subset of the plurality of mobile devices, the subset including the mobile devices respectively controllable by prospective survey takers that have qualified and accepted participation in the second phase survey;
a distribution adjustment module configured to monitor delivery and completion of the first phase survey in preparation for distribution of the second phase survey;
a data collection and presentation module configured to receive answers to the first phase survey and the second phase survey, the data collection and presentation module further configured to store the received answers in the database; and
a privacy protection module configured to protect privacy data communicated by respective ones of the plurality of mobile devices.

2. The mobile device interviewing system of claim 1, comprising:
an incentive module configured to select and communicate an object of value to at least one mobile device controllable by a survey taker that has completed the second survey.

3. The mobile device interviewing system of claim 2 wherein the incentive module is configured to deliver the object of value to a mobile device controlled by a user that has not provided personally identifying information to the mobile device interviewing system.

4. The mobile device interviewing system of claim 2 wherein the incentive module is configured to:
deliver a first incentive to a respective one of the mobile devices of the plurality of mobile devices controllable by a survey taker that has taken the first phase survey; and
deliver a second incentive to the respective one of the mobile devices of the plurality of mobile devices controllable by a survey taker that has taken the second phase survey.

5. The mobile device interviewing system of claim 1 wherein the campaign design and creation module is configured to automatically create the first phase survey and the second phase survey based on survey creation user input;

6. The mobile device interviewing system of claim 1 wherein the privacy data includes information to identify the prospective survey taker, the information including a name or email address.

7. The mobile device interviewing system of claim 1 wherein the privacy protection module is configured to protect privacy data by encrypting the privacy data.

8. The mobile device interviewing system of claim 1 wherein the privacy protection module is configured to temporarily collect private user information, disassociate survey responses from the private user information, and delete the private user information.

9. The mobile device interviewing system of claim 1 wherein the electronic user interface includes both wired and wireless communication circuits.

10. A no-dial cell phone server, comprising:
a database;
a client/user interface circuit configured to wirelessly communicate with a plurality of mobile devices, the client/user interface configured to accept input data from a survey commissioning client device and further used to output data to the survey commissioning client device;
a survey campaign design and creation module configured to direct creation of a user survey based on the input data; and
an incentive module configured to manage a plurality of user survey incentives, the user survey incentives associated with the user survey, a respective one of the user survey incentives automatically delivered in real-time to the mobile device upon completion of the user survey.

11. The mobile device of claim 10 wherein each mobile device of the plurality of mobile devices is used for voice and data communications.

12. The mobile device of claim 10 wherein the managing by the incentive module includes configuration to create, track, and distribute respective ones of the plurality of user survey incentives

13. The no-dial cell phone server of claim 10, comprising:
a first round distribution module configured to automatically distribute a first phase survey to the plurality of mobile devices, each mobile device respectively controllable by a prospective survey taker; and
a second round distribution module configured to automatically distribute a second phase survey to a subset of the plurality of mobile devices, the subset including the mobile devices respectively controllable by prospective survey takers that have qualified and accepted participation in the second phase survey.

14. The mobile device of claim 13 wherein automatic distribution of the second phase survey includes the automatic initiation of a voice telephone call, the voice telephone call between a survey administrator and a survey participant.

15. A non-transitory computer-readable storage medium whose stored contents configure a computing system to perform a method, the method comprising:
directing a campaign design and creation module to select a plurality of survey questions, a first subset of the plurality of survey questions forming a first phase survey and a second subset of the plurality of survey questions forming a second phase survey;
automatically distributing the first phase survey to a plurality of mobile devices, each mobile device respectively controllable by a prospective survey taker;
automatically distributing the second phase survey to a subset of the plurality of mobile devices, the subset including the mobile devices respectively controllable by prospective survey takers that have accepted participation in the second phase survey;
monitoring delivery and completion of the first phase survey in preparation for distribution of the second phase survey;
receiving answers to the first phase survey and the second phase survey; and
delivering a user survey incentive to the subset of the plurality of mobile devices based on receiving the answers to the second phase survey.

16. The non-transitory computer-readable storage medium according to claim 15 wherein automatically distributing the first phase survey includes distributing individual ones of the first phase survey at a configurable rate.

17. The non-transitory computer-readable storage medium according to claim 15 whose stored contents configure the computing system to perform the method, the method further comprising:
analyzing patterns detected in a response history of a known one of the prospective survey takers.

18. The non-transitory computer-readable storage medium according to claim 15 wherein automatically distributing the first phase survey includes distributing individual ones of the first phase survey based on a respective current location of each of the plurality of mobile devices.

19. The non-transitory computer-readable storage medium according to claim 18 wherein the respective current location is derived based on a telephone area code, a telephone prefix, or a global positioning system data point.

20. The non-transitory computer-readable storage medium according to claim 15 wherein delivering the user survey incentive includes electronically delivering an object of value to the subset of the plurality of mobile devices.
